(19) United States
(12) Patent Application Publication
(10) Pub. No.: US 2016/0042076 A1
(43) Pub. Date: Feb. 11, 2016

(54) SEARCH RECOMMENDATION METHOD AND DEVICE

(71) Applicant: BAIDU ONLINE NETWORK TECHNOLOGY (BEIJING) CO., LTD., Beijing (CN)

(72) Inventors: Jizhou HUANG, Beijing (CN); Lu WAN, Beijing (CN); Ying LI, Beijing (CN); Yongzhi JI, Beijing (CN); Yiming YAO, Beijing (CN); Deguo XIA, Beijing (CN)

(21) Appl. No.: 14/570,245

(22) Filed: Dec. 15, 2014

(30) Foreign Application Priority Data
Aug. 8, 2014 (CN) 201410389836.5

(51) Int. Cl. G06F 17/30

(52) U.S. Cl. CPC G06F 17/30867

(57) ABSTRACT

A search recommendation method and a search recommendation device are provided. The method comprises: receiving a query; generating an interactive question according to the query, and then providing the interactive question to a user; receiving an answer of the interactive question from the user, and then determining a level of the user according to the answer; and generating a recommendation according to the level of the user and the query and providing the recommendation to the user.

### CROSS-REFERENCE TO RELATED APPLICATION

This application claims priority to and benefits of Chinese Patent Application Serial No. 201410389836.5, filed with the State Intellectual Property Office of P. R. China on Aug. 8, 2014, the entire contents of which are incorporated herein by reference.

### FIELD

The present disclosure relates to a field of Internet, and more particularly relates to a search recommendation method and a search recommendation device.

### BACKGROUND

Since users search for information they need from massive information in internet, search engines have become indispensable tools. With a query input by a user, a search engine may obtain a search result from a server and display the search result to the user.

In order to improve user experience, the search engine may provide recommendations to the user. The search engine may display information related to the query on the right side of the search result for user's reference. For example, when a user searches for “The Voice of China”, recommendations on some actors or related videos may be displayed on the right side, such that the user may select the recommendations to view the recommendations. In relevant technologies, the recommendations on the right side of the search result are displayed to each user using a same template, and the content for each user are same too.

There are problems that unified information are provided to the user such that the user cannot obtain personal recommendations for himself/herself and as long as queries input by the user are same, recommendations displayed to the user are same, lacking of interestingness.

### SUMMARY

The present disclosure is aimed to solve at least one of the above problems to some extent.

Thus, a first objective of the present disclosure is to provide a search recommendation method. With the method, a recommendation is displayed to a user in a user interaction way so that the user may obtain a personal recommendation for himself/herself and a search process becomes more interesting by interactive questioning and answering.

A second objective of the present disclosure is to provide a search recommendation device.

In order to achieve the above objectives, embodiments of a first aspect of the present disclosure provide a search recommendation method. The method comprises: receiving a query; generating an interactive question according to the query, and then providing the interactive question to a user; receiving an answer corresponding to the interactive question from the user, and then determining a level of the user according to the answer; and generating a recommendation according to the level of the user and the query and providing the recommendation to the user.

With the search recommendation method according to embodiments of the present disclosure, an interactive question may be generated according to a query received and may be provided to the user, and then an answer corresponding to the interactive question may be received from a user, and a level of the user may be determined according to the answer, and finally a recommendation may be generated according to the level of the user and the query and may be provided to the user. By displaying the recommendation to the user in a user interaction way, on the one hand, the user may obtain more information he/she is more concerned with in an interactive process, i.e. the user may obtain a personal recommendation for himself/herself, and on the other hand, a search process becomes more interesting by interactive questioning and answering.

In order to achieve the above objectives, embodiments of a second aspect of the present disclosure provide a search recommendation device. The device comprises: a first receiving module configured for receiving a query; a generating module configured for generating an interactive question according to the query; a first providing module configured for providing the interactive question to a user; a second receiving module configured for receiving an answer corresponding to the interactive question from the user; a level determining module configured for determining a level of the user according to the answer; and a second providing module configured for generating a recommendation according to the level of the user and the query and providing the recommendation to the user.

With the search recommendation device according to embodiments of the present disclosure, an interactive question may be generated by the generating module according to a query received, the interactive question may be provided to a user by the first providing module, and then an answer corresponding to the interactive question may be received from the user by the second receiving module, and a level of the user may be determined by the level determining module according to the answer, a recommendation may be generated by the second providing module according to the level of the user and the query and then the recommendation may be provided to the user by the second providing module. By displaying the recommendation to the user in a user interaction way, on the one hand, the user may obtain more information he/she is more concerned with in an interaction process, i.e. the user may obtain a personal recommendation for himself/herself, and on the other hand, a search process becomes more interesting by interactive questioning and answering.

In order to achieve the above objectives, a computer readable storage medium according to embodiments of a third aspect of the present disclosure is provided. The computer readable storage medium comprises a computer program for executing the search recommendation method according to embodiments of the first aspect of the present disclosure, when running on a computer.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the accompanying drawings, in which:

FIG. 1 is a flow chart of a search recommendation method according to an embodiment of the present disclosure;

FIGS. 2(a) and 2(b) are schematic diagrams of an example with a query “The Voice of China Third Season” according to embodiments of the present disclosure;

FIGS. 3(a), 3(b) and 3(c) are schematic diagrams of an example with a query “national civil service exam” according to embodiments of the present disclosure;

FIGS. 4(a) and 4(b) are schematic diagrams of an example with a query “Killers of the Three Kingdoms” according to embodiments of the present disclosure;

FIGS. 5(a), 5(b), 5(c) and 5(d) are schematic diagrams of an example with a query “baby gets heat rash” according to embodiments of the present disclosure;

FIGS. 6(a), 6(b) and 6(c) are schematic diagrams of an example with a query “Global Mobile Internet Conference” according to embodiments of the present disclosure;

FIGS. 7(a), 7(b) and 7(c) are schematic diagrams of an example with a query “Liu Dehua” according to embodiments of the present disclosure;

FIG. 8 is a block diagram of a search recommendation device according to an embodiment of the present disclosure;

FIG. 9 is a block diagram of a search recommendation device according to another embodiment of the present disclosure;

FIG. 10 is a block diagram of a search recommendation device according to another embodiment of the present disclosure;

FIG. 11 is a block diagram of a search recommendation device according to another embodiment of the present disclosure; and

FIG. 12 is a block diagram of a search recommendation device according to another embodiment of the present disclosure.

### DETAILED DESCRIPTION

Reference will be made in detail to embodiments of the present disclosure, where the same or similar elements and the elements having same or similar functions are denoted by like reference numerals throughout the descriptions. The embodiments described herein with reference to drawings are explanatory, illustrative, and used to generally understand the present disclosure. The embodiments shall not be construed to limit the present disclosure.

The search recommendation method and device according to embodiments of the present disclosure will be described with reference to drawings. In order to solve the problem that a recommendation on the right side of a search result is displayed to users using a same template and contents of the recommendations are same such that the user may not obtain a personal recommendation for himself/herself, the present disclosure provides a search recommendation method. The method comprises: receiving a query; generating an interactive question according to the query, and then providing the interactive question to a user; receiving an answer corresponding to the interactive question from the user, and then determining a level of the user according to the answer; and generating a recommendation according to the level of the user and the query and providing the recommendation to the user.

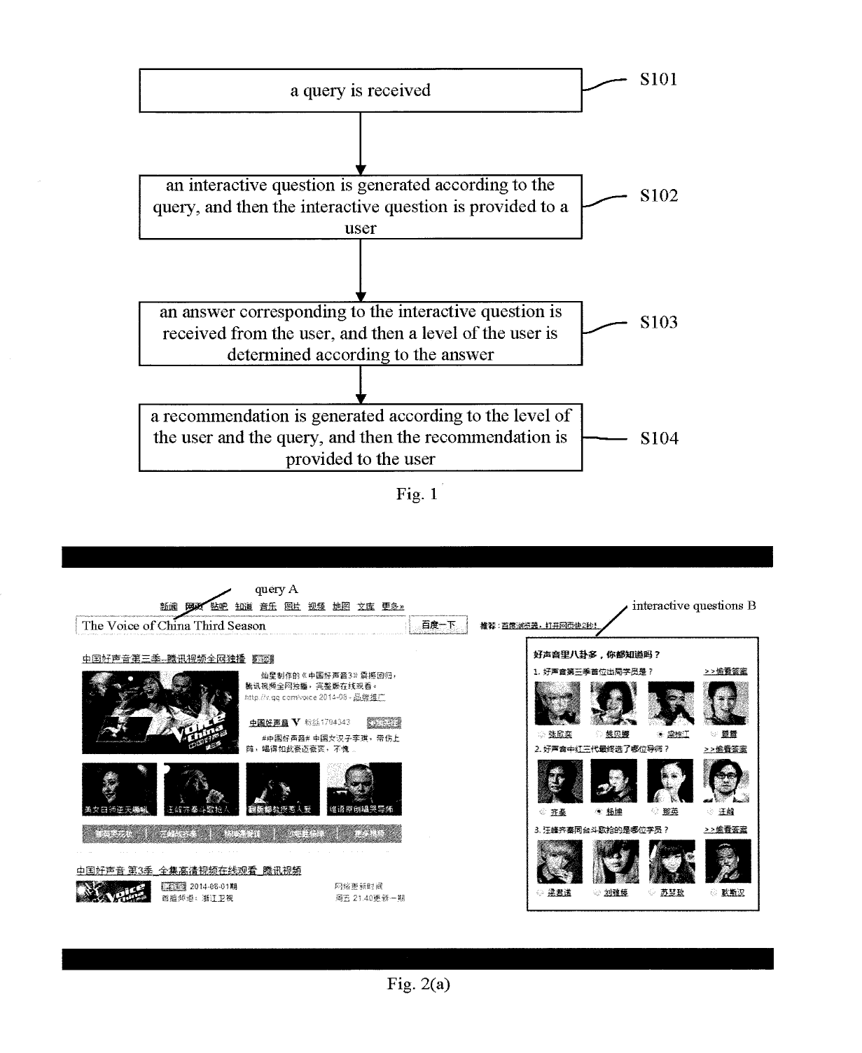

FIG. 1 is a flow chart of a search recommendation method according to an embodiment of the present disclosure. As shown in FIG. 1, the method comprises the following steps.

At step S101, a query is received.

In some embodiments, the query may be one or a combination of characters (such as words, pinyin, symbols and/or figures) in various languages.

At step S102, an interactive question is generated according to the query, and then the interactive question is provided to a user.

In some embodiments, the interactive question may be comprehended in a broad sense, which includes a question-answer type question or a game type question, but is not limited thereto. The question-answer type question includes, but is not limited to, a choice question, a true-false question or an essay question. An answer includes, but is not limited to, a picture, a text or a combination of a picture and a text (i.e. look at pictures and answer questions). Interactive questioning and answering may be realized by providing a question to a user and then receiving an answer from the user, which embodies an interaction process with the user.

Specifically, in some embodiments, an event related to the query may be determined according to the query. Then, the interactive question may be generated according to the event related to the query. Take a query “movies of Liu Dehua” for example. A main entity “Liu Dehua” of the query may be obtained analytically. Then, with the main entity “Liu Dehua”, all of attributes and values related to the main entity “Liu Dehua” may be queried from a knowledge base of a server to obtain triples of <entity, attribute, value>, such as <Liu Dehua, wife, Zhu Liqian>, and then interferential options may be obtained according to the attribute “wife”, for example, synonyms of “wife”: such as “rumored girlfriend”, “girlfriend”, “ex-girlfriend” and so on, and then corresponding values may be queried by using the synonyms as attributes to obtain final questions and answers to the questions, such as “Who is wife of Liu Dehua? A. Yu Kexin; B. Mei Yanfang; C. Zhu Liqian; D. Guan Zhilin”. Then, the difficulty of the questions may be assessed to obtain scores corresponding to the questions according to characteristics of each element in the triples of <entity, attribute, value>, such as appearance times, searching times, semantic similarity and so on. The above process is repeated until enough questions are obtained.

Further, in some embodiments, the step of providing the interactive question to the user comprises providing a search result page comprising a first area and a second area, in which the first area is configured to display the search result, and the second area is configured to display the interactive question and to receive the answer from the user. In some embodiments, the first area is on a left side of the search result page and the second area is on a right side of the search result page.

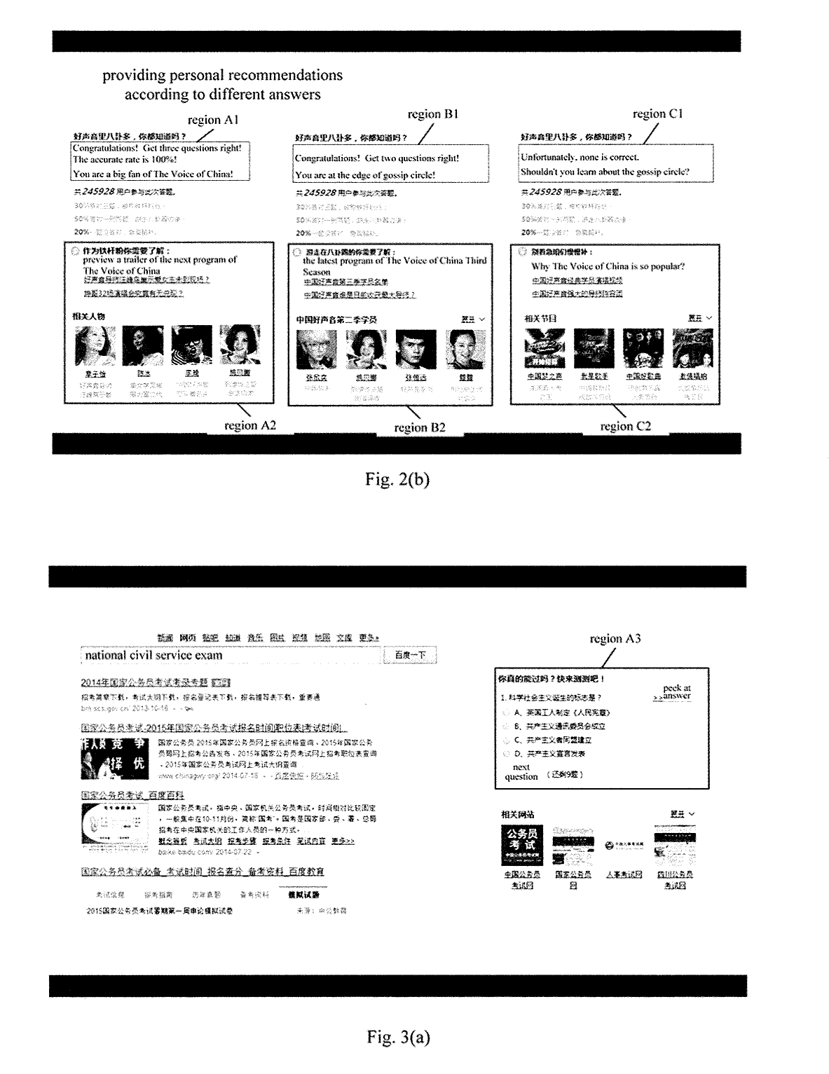

For example, as shown in FIG. 2(a), if a query A “The Voice of China Third Season” is input by the user, a corresponding search result may be obtained from a server according to the query and a search result page may be provided by a search engine. The search result is displayed on the left side (i.e. first area) of the search result page, and interactive questions B related to the query are displayed on the right side (i.e. second area) of the search result page, interactive questions B are choice questions and each choice is configured with a picture and a text, thus providing good visual and interactive experience for the user.

At step S103, an answer corresponding to the interactive question is received from the user, and then a level of the user is determined according to the answer.

Specifically, the answer corresponding to the interactive question may be received from the user via the second area of the search result page. Then, the level of the user may be determined according to accuracy of the answer. Further, in one embodiment, after the level of the user is determined according to the answer, the search recommendation method may further comprise a step of displaying the level of the user in the second area.

Take the answers corresponding to three interactive questions related to the query “The Voice of China Third Season” for example. Since the accuracy of the answers from different users is different, contents displayed in the second area are different. FIG. 2(b) is a schematic diagram of three kinds of contents displayed in the second area. As shown in FIG. 2(b), if all of the answers corresponding to the three interactive questions from the user are correct, the user is defined as “a big fan of The Voice of China” (as shown in region Al in FIG. 2(b)). If two of the answers corresponding to the three interactive questions from the user are correct, the user is defined as “a man at the edge of a gossip circle” (as shown in region B1 in FIG. 2(b)). If none of the answers corresponding to the three interactive questions from the user is correct, the user is defined as “a man needing to learn about the gossip circle” (as shown in region C1 in FIG. 2(b)).

Further, in one embodiment, after the level of the user is determined according to the answer, the search recommendation method may further comprise a step of updating the search result displayed in the first area according to the level of the user. More specifically, after the level of the user is determined according to the accuracy of the answer, the search result displayed in the first area may be updated according to the level of the user to obtain the search result which is more suitable for the user's requirements, and then the search result which is more suitable for the user's requirements may be displayed in the upper part of the first area such that the user may view them conveniently. Therefore, the search result which is more suitable for the user's requirements may be provided to the user according to the level of the user, thus improving the user experience.

At step S104, a recommendation is generated according to the level of the user and the query, and then the recommendation is provided to the user.

Specifically, in some embodiments, an event corresponding to the query may be determined according to the query, and then the recommendation may be generated according to the level of the user and the event and may be provided to the user. Take the query “movies of Liu Dehua” for example. The main entity “Liu Dehua” of the query may be obtained analytically. Then, with the main entity “Liu Dehua”, all of attributes and values related to the main entity “Liu Dehua” may be queried from a knowledge base of a server to obtain triples of <entity, attribute, value>, such as <Liu Dehua, wife, Zhu Liqian>, and then other related information may be obtained according to the attribute “wife”, for example, synonyms of “wife”: such as “rumored girlfriend”, “girlfriend”, “ex-girlfriend” and so on, and then corresponding values may be queried by using the synonyms as attributes to obtain a search result corresponding to the main entity “Liu Dehua”, such as “Who is wife of Liu Dehua?”, “group purchase of tickets for concert of Liu Dehua” and so on. Then, the search result may be filtered according to the level of the user to obtain recommendations corresponding to the level of the user, for example, if the level of the user is a highest level, i.e. the user is a loyal fan of Liu Dehua, a recommendation of “group purchase of tickets for concert of Liu Dehua” may be recommended to the user.

Take the answers corresponding to the three interactive questions related to the query “The Voice of China Third Season” for example. After the level of the user is determined according to the accuracy of the answers, recommendations may be generated according to the level of the user and the query, and then the recommendations may be displayed in the second area to the user. Since the levels of different users are different, the recommendations displayed in the second area are different. As shown in FIG. 2(b), if a user is defined as “a big fan of The Voice of China”, recommendations illustrated in region A2 such as “preview a trailer of the next program of The Voice of China” may be displayed in the second area to the user. If a user is defined as “a man at the edge of a gossip circle”, recommendations illustrated in region B2 such as “the latest program of The Voice of China Third Season” may be displayed in the second area to the user. If a user is defined as “a man needing to learn about the gossip circle”, recommendations illustrated in region C2 such as “Why The Voice of China is so popular” may be displayed in the second area to the user.

With the method according to embodiments of the present disclosure, an interactive question may be generated according to a query received and may be provided to the user, and then an answer corresponding to the interactive question may be received from a user, and a level of the user may be determined according to the answer, finally a recommendation may be generated according to the level of the user and the query and then the recommendation may be provided to the user. By displaying the recommendation to the user in a user interaction way, on the one hand, the user may obtain information he/she is more concerned with in an interaction process, i.e. the user may obtain a personal recommendation for himself/herself, and on the other hand, a search process becomes more interesting by interactive questioning and answering.

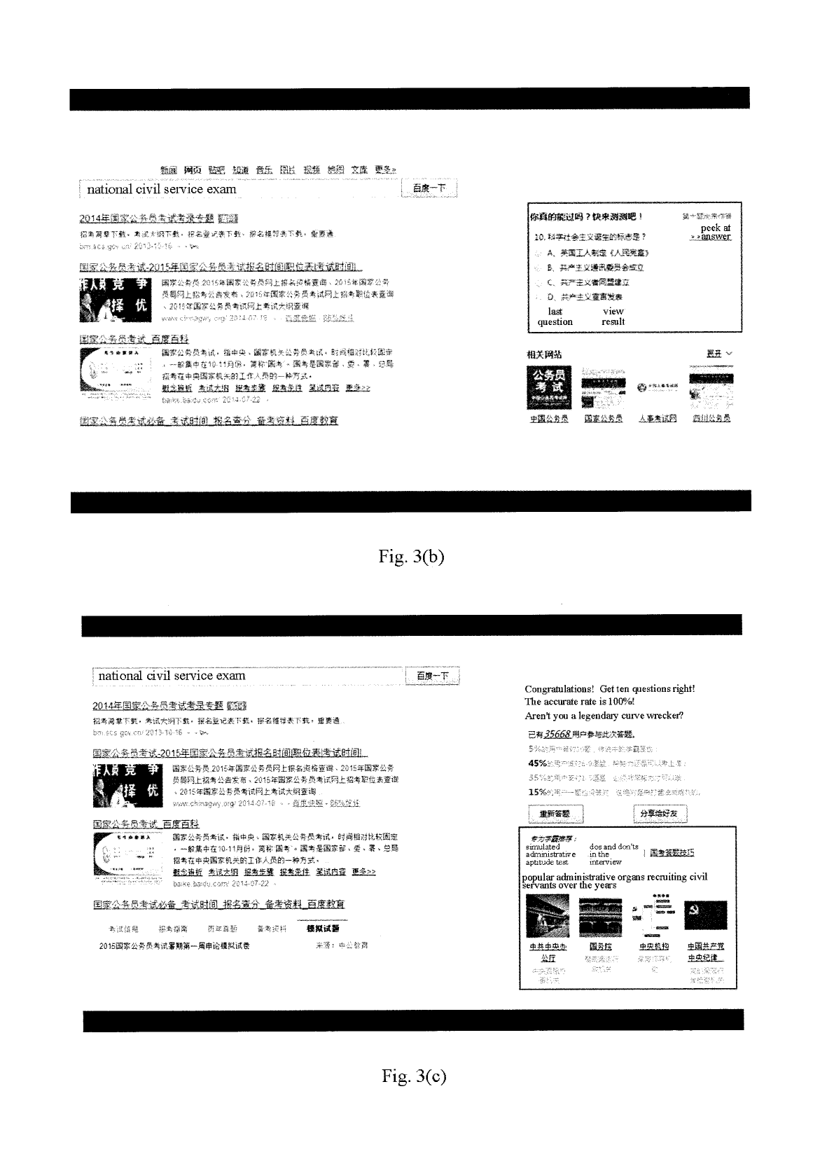

It should be noted that in one embodiment, a number of the interactive questions may be determined by the system according to the query and the events related to the query. If the number of the interactive questions is more than one (such as ten), the interactive questions may be displayed in the second area on multiple pages via a “next question” button and/or a “last question” button. Take a query “national civil service exam” for example. As shown in FIG. 3(a), interactive questions with respect to the query “national civil service exam” may be displayed in region A3 of the second area. If an answer to a current question is provided and the “next question” button is clicked, a next interactive question may be displayed. If the answer to the current question is not provided but the “next question” button or a “view result” button is clicked, a prompt for indicating that the current question is not answered may be displayed in the second area, as shown in FIG. 3(b). If the answers corresponding to all the interactive questions from the user are correct and the “view result” button is clicked, the user may be defined as “a legendary curve wrecker”. At this time, links for searching for related information such as “simulated administrative aptitude test”, “dos and don'ts in the interview” may be recommended to the user. Meanwhile, general recommendations such as “popular administrative organs recruiting civil servants over the years” may be recommended to the user, as shown in FIG. 3(c).

In order to make those skilled in the art better understand the present disclosure, the present disclosure will be described with examples based on different queries.

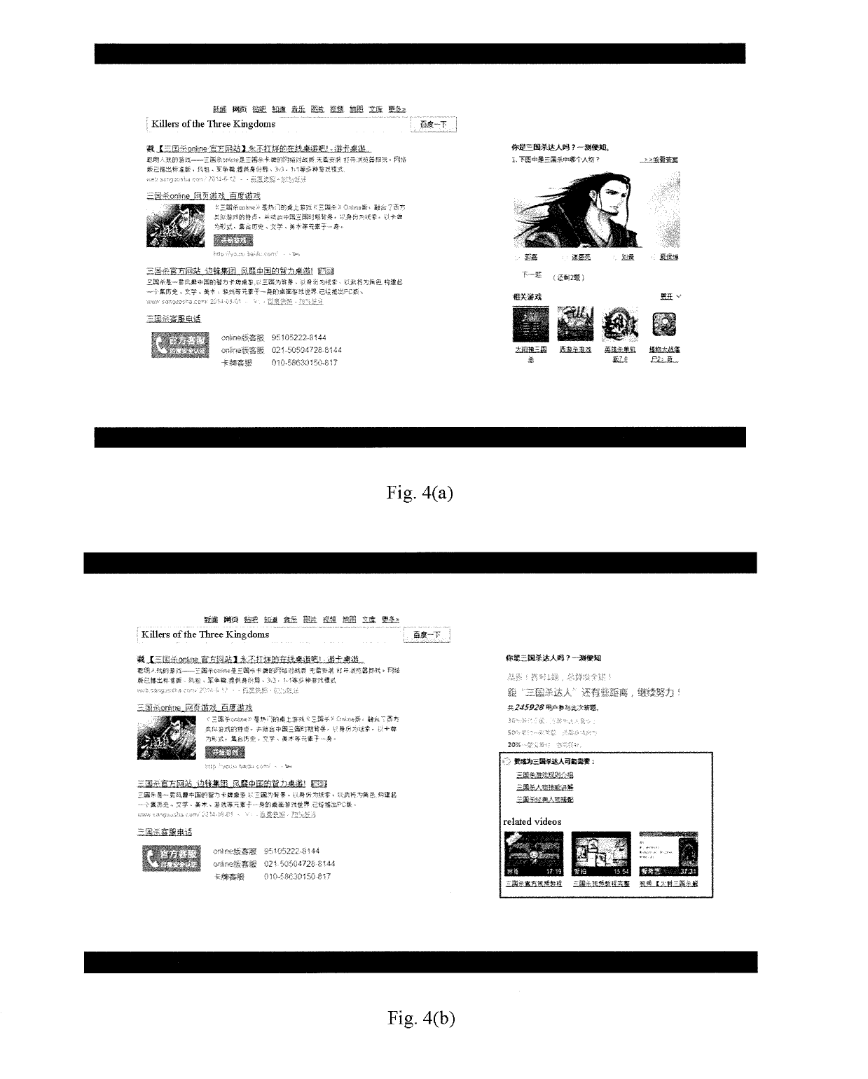

For example, the search result which is more suitable for the user's requirements may be recommended by guessing the content of a game. Take a query “Killers of the Three Kingdoms” for example. As shown in FIG. 4(a), interactive questions displayed in the second area are game type questions, and each game type question includes a picture and a plurality of options, i.e. look at pictures and answer questions. If all of the questions are answered by the user, the level of the user and recommendations corresponding to the level of the user may be displayed in the second area. The recommendations may include videos, as shown in FIG. 4(b).

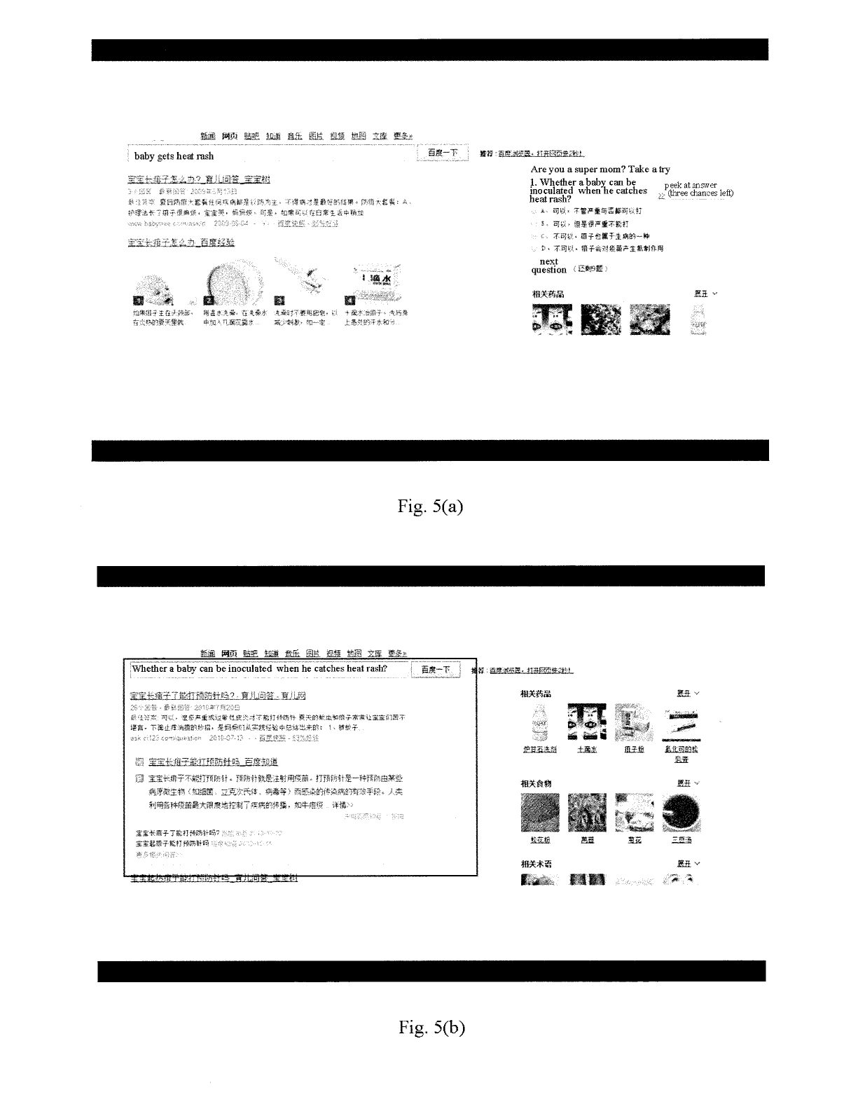

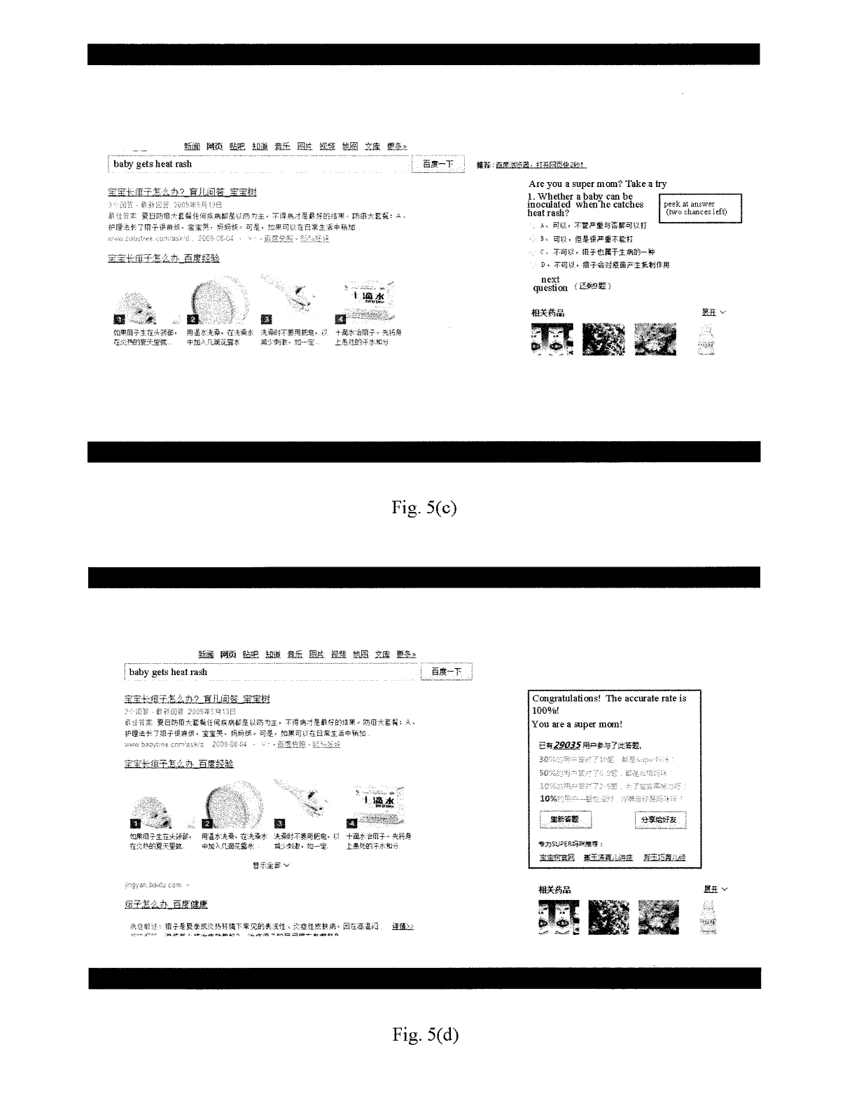

Take a query “baby gets heat rash” for example. As shown in FIG. 5(a), if the query “baby gets heat rash” is input by the user, a question corresponding to the query may be regarded as a question about how to raise a baby. At this time, the search engine may generate interactive questions of “Are you a super mom? Take a try” according to a test for testing a qualified mom. If a “peek at answer” button is clicked by the user, the current question may be used as a query and be queried, and then the search result related to the query may be displayed in the first area for the user's reference, as shown in FIG. 5(b). If the user returns and continues answering the interactive questions, a tip in the “peek at answer” button indicates that how many chances are left for peeking at the answer such as “two chances left”, as shown in FIG. 5(c). If all of the interactive questions are answered, the level of the user and the recommendations corresponding to the level of the user are displayed in the second area.

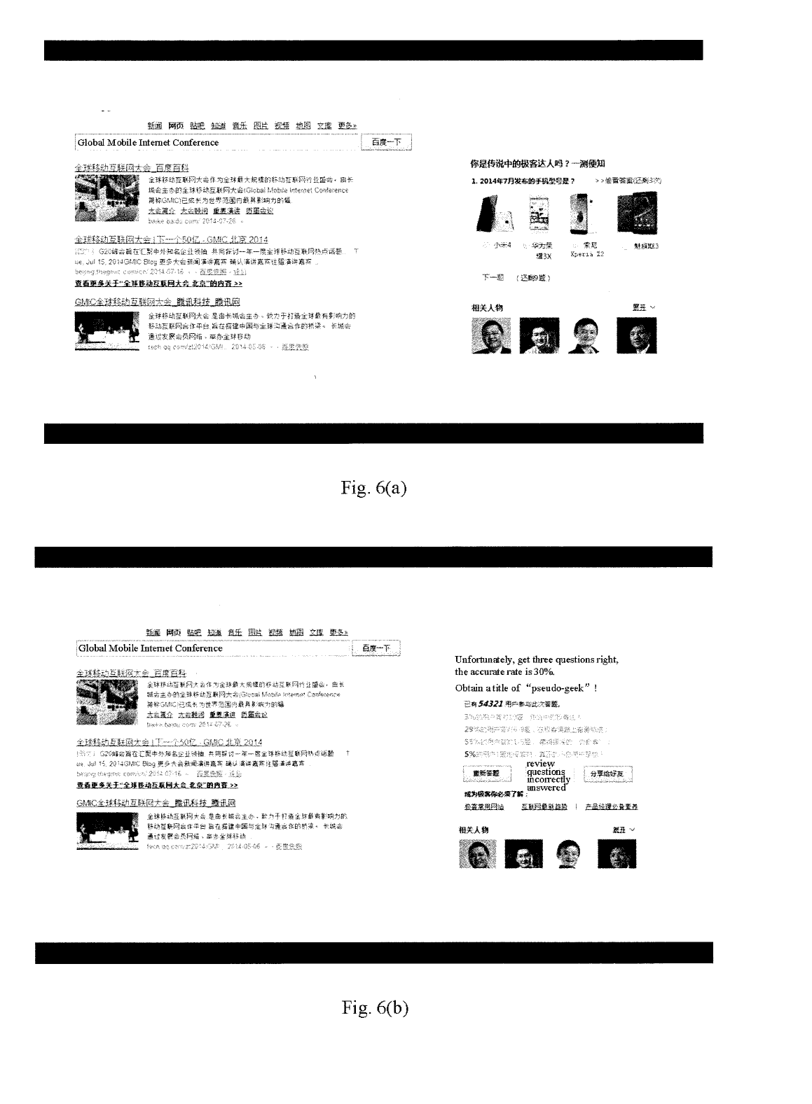

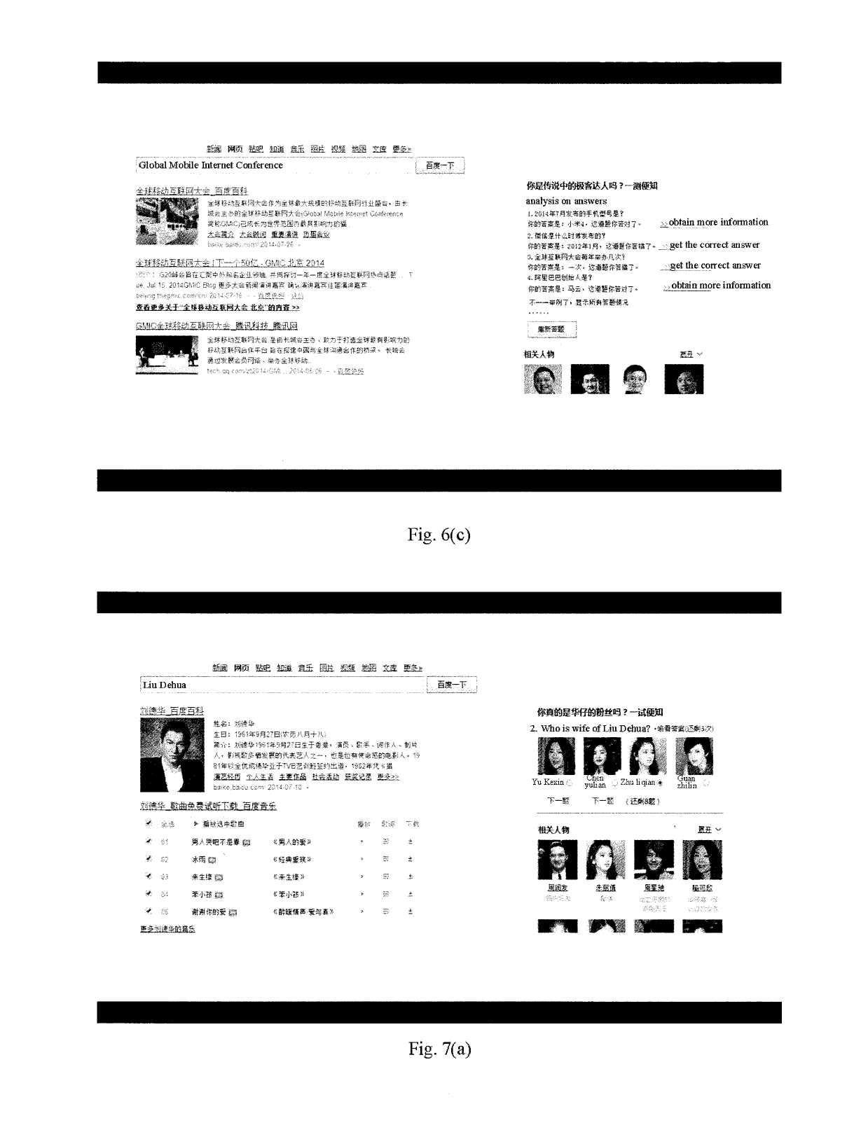

Take a query “Global Mobile Internet Conference” for example. As shown in FIG. 6(a), interactive questions related to the query “Global Mobile Internet Conference” may be displayed in the second area. If all of the interactive questions are answered by the user, the level of the user and recommendations corresponding to the level of the user may be displayed in the second area, as shown in FIG. 6(b). If the user wonders which one of his answers is correct and which one is incorrect, he/she may click a “review questions incorrectly answered” button illustrated in FIG. 6(b), and then an analysis on his answers may be displayed in the second area, as shown in FIG. 6(c), such that the user may obtain information about his answers. With a “obtain more information” button, the user may obtain more information about a question correctly answered by the user, and with a “get the correct answer” button, the user may obtain a correct answer corresponding to a question incorrectly answered by the user.

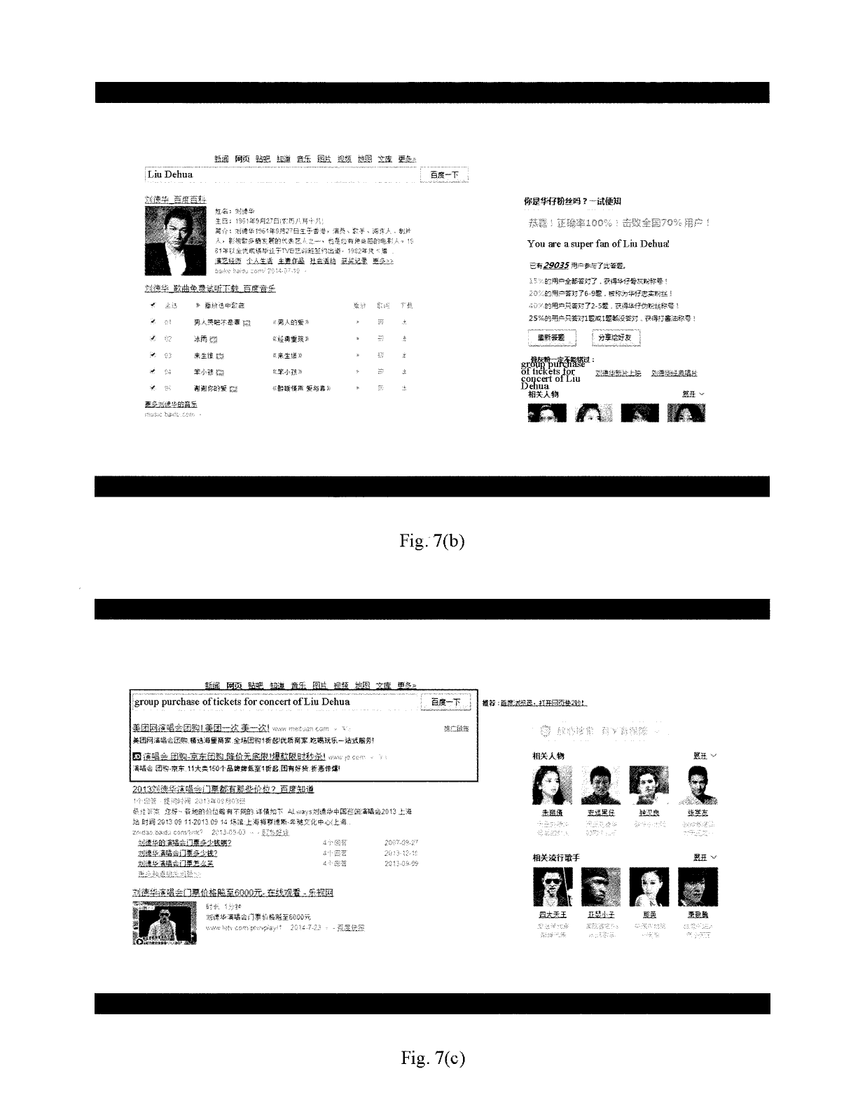

Take the query “Liu Dehua” for example. As shown in FIG. 7(a), interactive questions related to the query “Liu Dehua” may be displayed in the second area. If all of the interactive questions are answered by the user, the level of the user and recommendations corresponding to the level of the user may be displayed in the second area, as shown in FIG. 7(b). If the user clicks a recommended link of “group purchase of tickets for concert of Liu Dehua”, “group purchase of tickets for concert of Liu Dehua” may be used as the query and be queried, and then the search result related to the query may be displayed in the first area for the user's reference, as shown in FIG. 7(c).

In order to realize the above embodiments, the present disclosure provides a search recommendation device. The device comprises: a first receiving module configured for receiving a query; a generating module configured for generating an interactive question according to the query; a first providing module configured for providing the interactive question to a user; a second receiving module configured for receiving an answer corresponding to the interactive question from the user; a level determining module configured for determining a level of the user according to the answer; and a second providing module configured for generating a recommendation according to the level of the user and the query and providing the recommendation to the user.

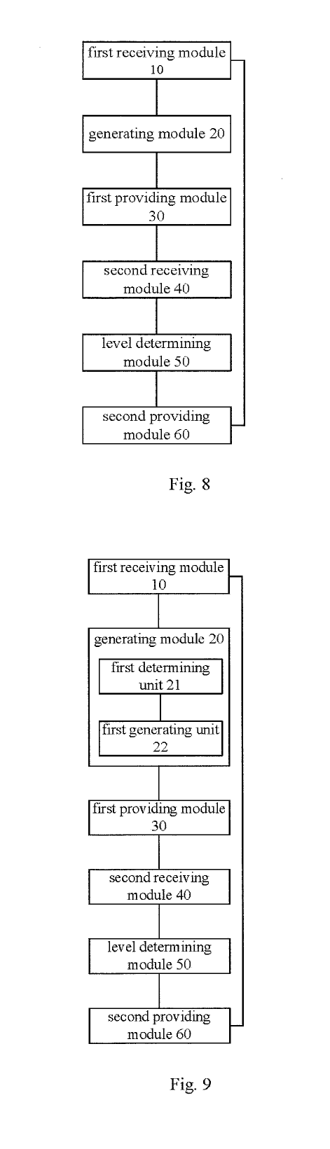

FIG. 8 is a block diagram of a search recommendation device according to an embodiment of the present disclosure. As shown in FIG. 8, the search recommendation device may comprise a first receiving module 10, a generating module 20, a first providing module 30, a second receiving module 40, a level determining module 50 and a second providing module 60.

Specifically, the first receiving module 10 may be configured for receiving a query. In some embodiments, the query may be one or a combination of characters (such as words, pinyin, symbols and/or figures) in various languages.

The generating module 20 may be configured for generating an interactive question according to the query. In some embodiments, the interactive question may be comprehended in a broad sense, which includes a question-answer type question or a game type question, but is not limited thereto. The question-answer type question includes, but is not limited to, a choice question, a true-false question, or an essay question. An answer includes, but is not limited to, a picture, a text or a combination of a picture and a text (i.e. look at pictures and answer questions). Interactive questioning and answering may be realized by providing questions to a user and then receiving answers from the user, which embodies an interaction process with the user.

Further, in one embodiment, as shown in FIG. 9, the generating module 20 may comprise a first determining unit 21 and a first generating unit 22. The first determining unit 21 may be configured for determining an event related to the query according to the query. The first generating unit 22 may be configured for generating the interactive question according to the event related to the query. Take a query “movies of Liu Dehua” for example. A main entity “Liu Dehua” of the query may be obtained analytically. Then, with the main entity “Liu Dehua”, all of attributes and values related to the main entity “Liu Dehua” may be queried from a knowledge base of a server to obtain triples of <entity, attribute, value>, such as <Liu Dehua, wife, Zhu Liqian>, and then interferential options may be obtained according to the attribute “wife”, for example, synonyms of “wife”: such as “rumored girlfriend”, “girlfriend”, “ex-girlfriend” and so on, and then corresponding values may be queried by using the synonyms as attributes to obtain final questions and answers to the questions, such as “Who is wife of Liu Dehua? A. Yu Kexin; B. Mei Yanfang; C. Zhu Liqian; D. Guan Zhilin”. Then, the difficulty of the questions may be assessed to obtain scores corresponding to the questions according to characteristics of each element in the triples of <entity, attribute, value>, such as appearance times, searching times, semantic similarity and so on. The above process is repeated until enough questions are obtained.

The first providing module 30 may be configured for providing the interactive question to the user. Specifically, in some embodiments, the first providing module 30 may be configured for providing a search result page comprising a first area and a second area, the first area is configured to display the search result, and the second area is configured to display the interactive question and to receive the answer from the user. In some embodiments, the first area is on a left side of the search result page and the second area is on a right side of the search result page.

For example, as shown in FIG. 2(a), if a query A “The Voice of China Third Season” is input by the user, a corresponding search result may be obtained from a server according to the query and a search result page may be provided by the first providing module 30. The search result is displayed on the left side (i.e. first area) of the search result page, and interactive questions B related to the query are displayed on the right side (i.e. second area) of the search result page, interactive questions B are choice questions and each choice is configured with a picture and a text, thus providing good visual and interactive experience for the user.

The second receiving module 40 may be configured for receiving an answer corresponding to the interactive question from the user. The level determining module 50 may be configured for determining a level of the user according to the answer. Specifically, the answer corresponding to the interactive question may be received from the user via the second area of the search result page by the second receiving module 40.

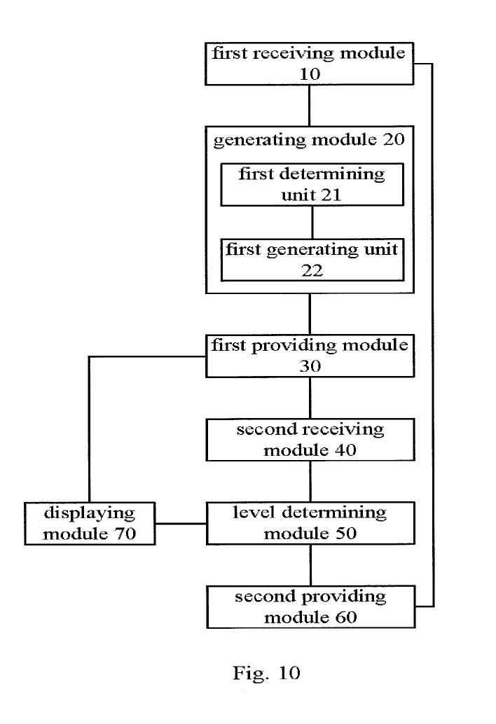

The level of the user may be determined by the level determining module 50 according to the accuracy of the answer. Further, in one embodiment, as shown in FIG. 10, the search recommendation device may further comprise a displaying module 70. The displaying module 70 may be configured for displaying the level of the user in the second area.

Take the answers corresponding to three interactive questions related to the query “The Voice of China Third Season” for example. Since the accuracy of the answers from different users is different, contents displayed in the second area are different. FIG. 2(b) is a schematic diagram of three kinds of contents displayed in the second area. As shown in FIG. 2(b), if all of the answers corresponding to the three interactive questions from the user are correct, the user is defined as “a big fan of The Voice of China” by the level determining module 50, and the level may be displayed in the second area (as shown in region Al in FIG. 2(b)) by the displaying module 70. If two of the answers corresponding to the three interactive questions from the user are correct, the user is defined as “a man at the edge of a gossip circle” by the level determining module 50, and the level may be displayed in the second area (as shown in region B1 in FIG. 2(b)) by the displaying module 70. If none of the answers corresponding to the three interactive questions from the user is correct, the user is defined as “a man needing to learn about the gossip circle” by the level determining module 50, and the level may be displayed in the second area (as shown in region C1 in FIG. 2(b)) by the displaying module 70.

The second providing module 60 may be configured for generating a recommendation according to the level of the user and the query, and for providing the recommendation to the user.

Take the answers corresponding to the three interactive questions related to the query “The Voice of China Third Season” for example. After the level of the user is determined by the second providing module 60 according to the accuracy of the answers, recommendations may be generated according to the level of the user and the query, and then the recommendations may be displayed in the second area to the user. Since the levels of different users are different, the recommendations displayed in the second area are different. As shown in FIG. 2(b), if a user is defined as “a big fan of The Voice of China”, recommendations illustrated in region A2 such as “preview a trailer of the next program of The Voice of China” may be displayed in the second area to the user. If a user is defined as “a man at the edge of a gossip circle”, recommendations illustrated in region B2 such as “the latest program of The Voice of China Third Season” may be displayed in the second area to the user. If a user is defined as “a man needing to learn about the gossip circle”, recommendations illustrated in region C2 such as “Why The Voice of China is so popular” may be displayed in the second area to the user.

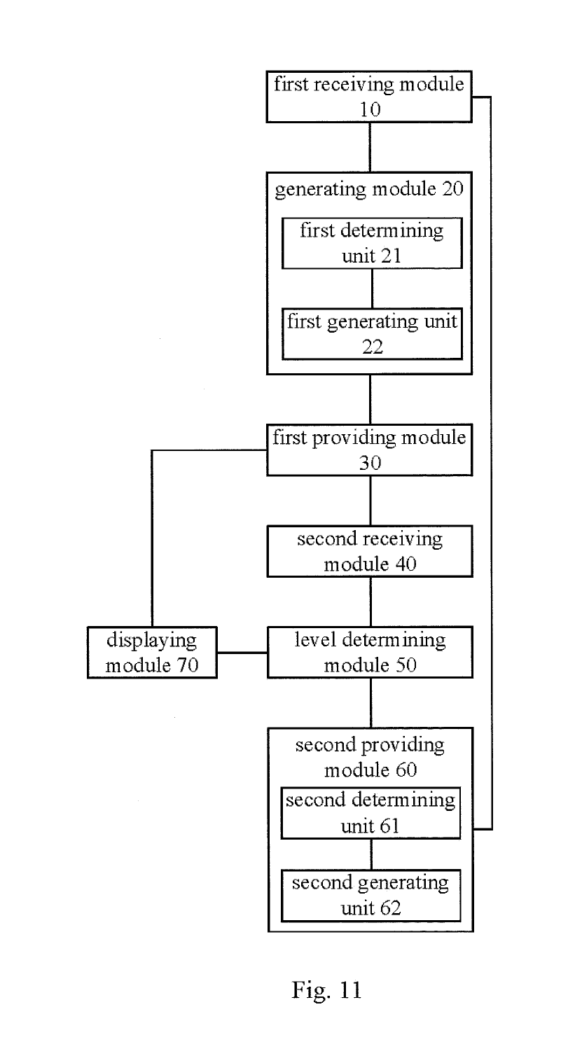

Further, in one embodiment, as shown in FIG. 11, the second providing module 60 may comprise a second determining unit 61 and a second generating unit 62. The second determining unit 61 may be configured for determining an event corresponding to the query according to the query. The second generating unit 62 may be configured for generating the recommendation according to the level of the user and the event and for providing the recommendation to the user. Take the query “movies of Liu Dehua” for example. The main entity “Liu Dehua” of the query may be obtained analytically. Then, with the main entity “Liu Dehua”, all of attributes and values related to the main entity “Liu Dehua” may be queried from a knowledge base of a server to obtain triples of <entity, attribute, value>, such as <Liu Dehua, wife, Zhu Liqian>, and then other related information may be obtained according to attribute “wife”, for example, synonyms of “wife”: such as “rumored girlfriend”, “girlfriend”, “ex-girlfriend” and so on, and then corresponding values may be queried by using the synonyms as the attributes to obtain a search result corresponding to the main entity “Liu Dehua”, such as “Who is wife of Liu Dehua?”, “group purchase of tickets for concert of Liu Dehua” and so on. Then, the search result may be filtered according to the level of the user to obtain recommendations corresponding to the level of the user, for example, if the level of the user is a highest level, i.e. the user is a loyal fan of Liu Dehua, a recommendation of “group purchase of tickets for concert of Liu Dehua” may be recommended to the user.

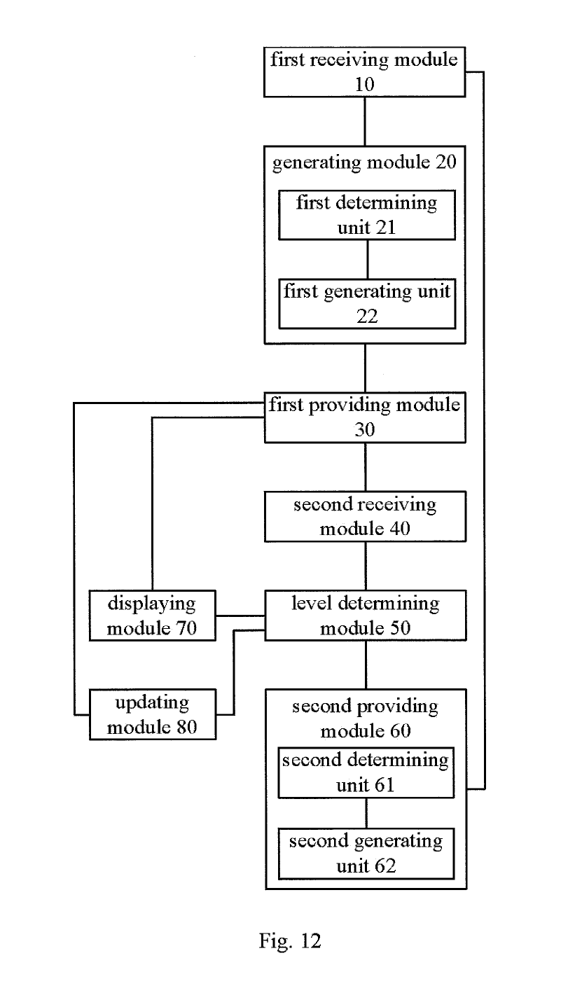

Further, in one embodiment, as shown in FIG. 12, the search recommendation device further comprises an updating module 80. The updating module 80 may be configured for updating the search result displayed in the first area according to the level of the user. More specifically, after the level of the user is determined according to the accuracy of the answer, the search result displayed in the first area may be updated by the updating module 80 according to the level of the user to obtain a search result which is more suitable for the user's requirements, and then the search result which is more suitable for the user's requirements may be displayed in the upper part of the first area such that the user may view them conveniently. Therefore, the search result which is more suitable for the user's requirements may be provided to the user according to the level of the user, thus improving the user experience.

With the search recommendation device according to embodiments of the present disclosure, an interactive question may be generated by the generating module according to a query received, the interactive question may be provided to a user by the first providing module, and then an answer corresponding to the interactive question may be received from the user by the second receiving module, and a level of the user may be determined by the level determining module according to the answer, a recommendation may be generated by the second providing module according to the level of the user and the query and then the recommendation may be provided to the user by the second providing module. By displaying the recommendation to the user in a user interaction way, on the one hand, the user may obtain information he/she is more concerned with in an interaction process, i.e. the user may obtain a personal recommendation for himself/herself, and on the other hand, a search process becomes more interesting by interactive questioning and answering.

A computer readable storage medium according to embodiments of the present disclosure is also provided. The computer readable storage medium comprises a computer program for executing the search recommendation method according to the above embodiments of the present disclosure, when running on a computer.

Reference throughout this specification to “one embodiment”, “some embodiments,” “an embodiment” , “a specific example,” or “some examples,” means that a particular feature, structure, material, or characteristic described in connection with the embodiment or example is included in at least one embodiment or example of the present disclosure. Thus, the appearances of the phrases in various places throughout this specification are not necessarily referring to the same embodiment or example of the present disclosure. Furthermore, the particular features, structures, materials, or characteristics may be combined in any suitable manner in one or more embodiments or examples. In addition, in a case without contradictions, different embodiments or examples or features of different embodiments or examples may be combined by those skilled in the art.

In addition, terms such as “first” and “second” are used herein for purposes of description and are not intended to indicate or imply relative importance or significance.

Thus, the feature defined with “first” and “second” may comprise one or more this feature. In the description of the present disclosure, “a plurality of” means two or more than two, unless specified otherwise.

It will be understood that, the flow chart or any process or method described herein in other manners may represent a module, segment, or portion of code that comprises one or more executable instructions to implement the specified logic function(s) or that comprises one or more executable instructions of the steps of the progress. And the scope of a preferred embodiment of the present disclosure includes other implementations in which the order of execution may differ from that which is depicted in the flow chart, which should be understood by those skilled in the art.

The logic and step described in the flow chart or in other manners, for example, a scheduling list of an executable instruction to implement the specified logic function(s), it can be embodied in any computer-readable medium for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the printer registrar for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, magnetic tapes, magnetic floppy diskettes, magnetic hard drives, or compact discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

Those skilled in the art shall understand that all or parts of the steps in the above exemplifying method of the present disclosure may be achieved by commanding the related hardware with programs. The programs may be stored in a computer readable storage medium, and the programs comprise one or a combination of the steps in the method embodiments of the present disclosure when run on a computer.

In addition, each function cell of embodiments of the present disclosure may be integrated in a processing module, or these cells may be separate physical existence, or two or more cells are integrated in a processing module. The integrated module may be realized in a form of hardware or in a form of software function modules. When the integrated module is realized in a form of software function module and is sold or used as a standalone product, the integrated module may be stored in a computer readable storage medium.

The storage medium mentioned above may be read-only memories, magnetic disks, CD, etc. Although explanatory embodiments have been shown and described, it would be appreciated that the above embodiments are explanatory and cannot be construed to limit the present disclosure, and changes, alternatives, and modifications can be made in the embodiments without departing from scope of the present disclosure by those skilled in the art.

What is claimed is:

1. A search recommendation method, comprising:
receiving a query;
generating an interactive question according to the query, and then providing the interactive question to a user;
receiving an answer corresponding to the interactive question from the user, and then determining a level of the user according to the answer; and
generating a recommendation according to the level of the user and the query and providing the recommendation to the user.

2. The search recommendation method according to claim 1, wherein generating an interactive question according to the query comprises:
determining an event related to the query according to the query; and
generating the interactive question according to the event related to the query.

3. The search recommendation method according to claim 1, wherein providing the interactive question to the user comprises:
providing a search result page comprising a first area and a second area, wherein the first area is configured to display a search result, and the second area is configured to display the interactive question and to receive the answer from the user.

4. The search recommendation method according to claim 3, wherein the first area is on a left side of the search result page and the second area is on a right side of the search result page.

5. The search recommendation method according to claim 3, further comprising:
updating the search result displayed in the first area according to the level of the user.

6. The search recommendation method according to claim 3, further comprising:
displaying the level of the user in the second area.

7. The search recommendation method according to claim 1, wherein generating a recommendation according to the level of the user and the query and providing the recommendation to the user comprises:
determining an event corresponding to the query according to the query;
generating the recommendation according to the level of the user and the event, and providing the recommendation to the user.

8. A search recommendation device, comprising:
a first receiving module, configured for receiving a query;
a generating module, configured for generating an interactive question according to the query;
a first providing module, configured for providing the interactive question to a user;
a second receiving module, configured for receiving an answer corresponding to the interactive question from the user;
a level determining module, configured for determining a level of the user according to the answer; and
a second providing module, configured for generating a recommendation according to the level of the user and the query and for providing the recommendation to the user.

9. The search recommendation device according to claim 8, wherein the generating module comprises:
a first determining unit, configured for determining an event related to the query according to the query; and
a first generating unit, configured for generating the interactive question according to the event related to the query.

10. The search recommendation device according to claim 8, wherein the first providing module is further configured for providing a search result page comprising a first area and a second area, wherein the first area is configured to display a search result, and the second area is configured to display the interactive question and to receive the answer from the user.

11. The search recommendation device according to claim 10, wherein the first area is on a left side of the search result page and the second area is on a right side of the search result page.

12. The search recommendation device according to claim 10, further comprising:
an updating module, configured for updating the search result displayed in the first area according to the level of the user.

13. The search recommendation device according to claim 10, further comprising:
a displaying module, configured for displaying the level of the user in the second area.

14. The search recommendation device according to claim 8, wherein the second providing module comprises:
a second determining unit, configured for determining an event corresponding to the query according to the query; and
a second generating unit, configured for generating the recommendation according to the level of the user and the event, and for providing the recommendation to the user.

15. A computer readable storage medium, comprising a computer program for executing steps of:
receiving a query;
generating an interactive question according to the query, and then providing the interactive question to a user;
receiving an answer corresponding to the interactive question from the user, and then determining a level of the user according to the answer; and
generating a recommendation according to the level of the user and the query and providing the recommendation to the user,
when running on a computer.
